(19) United States
(12) Patent Application Publication
(10) Pub. No.: US 2009/0081612 A1
(43) Pub. Date: Mar. 26, 2009

(54) IMPLANT

(75) Inventors: Lars Jorneus, Frillesas (SE); Sanel Duric, Gothenburg (SE)

Correspondence Address: KNOBBE MARTENS OLSON & BEAR LLP, 2040 MAIN STREET, FOURTEENTH FLOOR, IRVINE, CA, 92614, US

(73) Assignee: NOBEL BIOCARE AB (PUBL), Goteborg (SE)

(21) Appl. No.: 10/583,817

(22) PCT Filed: Dec. 20, 2004
(86) PCT No.: PCT/SE2004/001917

§ 371 Date: Dec. 8, 2008

(30) Foreign Application Priority Data
Dec. 22, 2003 (SE) 0303460-0

(51) Int. Cl. A61C 8/00

(52) U.S. Cl. 433/173

(57) ABSTRACT

An implant (5) can be fitted in an implantation site in a hole (4) formed in a jaw bone (1) where it is exposed to an impinging force or impinging forces (F1, F2). The implant can comprise one or more peripherally extending surfaces (5d) which are arranged at its upper/outer portion (5b) and which can be placed against a jaw bone part (3) at the outlet opening (4b) of the hole. Each surface (5d) is provided with a pattern (8) of grooves and/or recesses. Some of these are designed so that, in the implantation site, they extend substantially at right angles to, and if appropriate parallel to, said forces (F1, F2) when these assume principal directions differing from the longitudinal direction (5c) of the implant. By virtue of this arrangement, it is possible to achieve effective load-bearing in different implantation situations.

The present invention relates to an implant which can be fitted in an implantation site in a hole formed in a jaw bone, where the implant is exposed to an impinging force or impinging forces. The implant comprises one or more peripherally extending surfaces which are arranged at its upper/outer portion and which can be placed against the jaw bone and soft tissue at the outlet opening of the hole.

The present invention is based, inter alia, on the concept that osteoconduction can be increased with a certain type of groove or recess in the surface. Reference is made in this connection to WO 97/05238 (Boyde) and to the patent application SE 03.03322-2 filed by the Applicant of the present patent application.

When fitting implants of the type in question, it is important to be able to achieve excellent osteoconduction between the jaw bone in question and the implant and to avoid bone absorption, even marginal bone absorption, during the stages of implantation and incorporation. It is also important that the implant is able to resist the force or forces which impinge on the implant in a principal direction. An inclination of the implant, for example because of the jaw bone situation, must, not give rise to movements between implant and jaw bone which prevent a good implantation result. The same applies when the implant supports a tooth replacement in a position which, for example during chewing movements, means that the principal directions of the force or forces are inclined in relation to the longitudinal direction of the implant, which can result in disadvantageous forces acting on the implant and can cause a tendency for the implant to loosen.

The main object of the present invention is, among other things, to solve this problem and it proposes a pattern arrangement of grooves and/or recesses which, in addition to the known osteoconduction of the grooves, also makes the implant resistant to inclinations between the principal direction of an impinging force or impinging forces and the longitudinal direction of the implant.

The increased resistance to forces directed at an incline in relation to the implant must also be such as to ensure that bacteria and/or organisms which tend to cause inflammation do not penetrate from the implant's upper/outer parts (oral cavity) to the deeper-lying or lower parts of the implant. The invention also solves this problem.

The feature that can principally be regarded as characterizing an implant according to the invention is that each surface is provided with a pattern of grooves and/or recesses and that some, for example 20% or more, of the grooves and/or recesses are arranged so that, in the implanted position, they extend substantially at right angles in relation to said force or forces when these latter assume a principal direction or principal directions differing from the longitudinal direction of the implant.

In further developments of the inventive concept, the grooves and/or recesses are closed, which means here that there is no connection between the upper and lower parts of the implant portion in question and that, in this way, passage of bacteria and/or organisms from the upper to the lower parts of the implant is prevented. In a preferred embodiment, the recesses are chosen in the range of 50-100 μm and have groove or recess depths in the range of 100-150 μm. In the case where the implant has an internal socket for a tool, which causes different material thicknesses at the upper parts of the implant, the pattern arrangement is provided only at those parts of the portion having the greater material thicknesses. Different pattern arrangements can be provided. Further developments of the inventive concept are set out, inter alia, in the attached dependent claims.

The above goes against the prevailing views in the dental field by proposing that the surface will be patterned with grooves/recesses. Normally, the aim is for the surface at the outlet opening of the hole to be polished so as to make it easier to keep the surface clean from bacteria and/or organisms of a nature tending to cause inflammation. Such polishing, however, counters said osteoconduction function and makes integration between the surface material of the implant and the jaw bone difficult. The osteoconduction function of the grooves improves bone incorporation, and arranging the grooves in the manner proposed according to the invention counteracts microscopic movements and shearing stresses in the already incorporated bone for the purpose of maintaining the bone level and of preventing bone absorption. Methods known per se can be used to produce the groove and recess arrangements. Thus, it may be possible to use mechanical working, for example turning, milling or engraving. It is also known per se to produce the groove and/of recess arrangement by laser treatment of the surface. Different implants can be provided with different patterns to meet different implantation situations, for example different tooth functions, implant positions in the dentine, etc. Implants with different patterns can thus be made available on the market to provide choice to the specialists concerned.

A presently proposed embodiment of an arrangement having the features characteristic of the invention will be described below with reference to the attached drawings, in which:

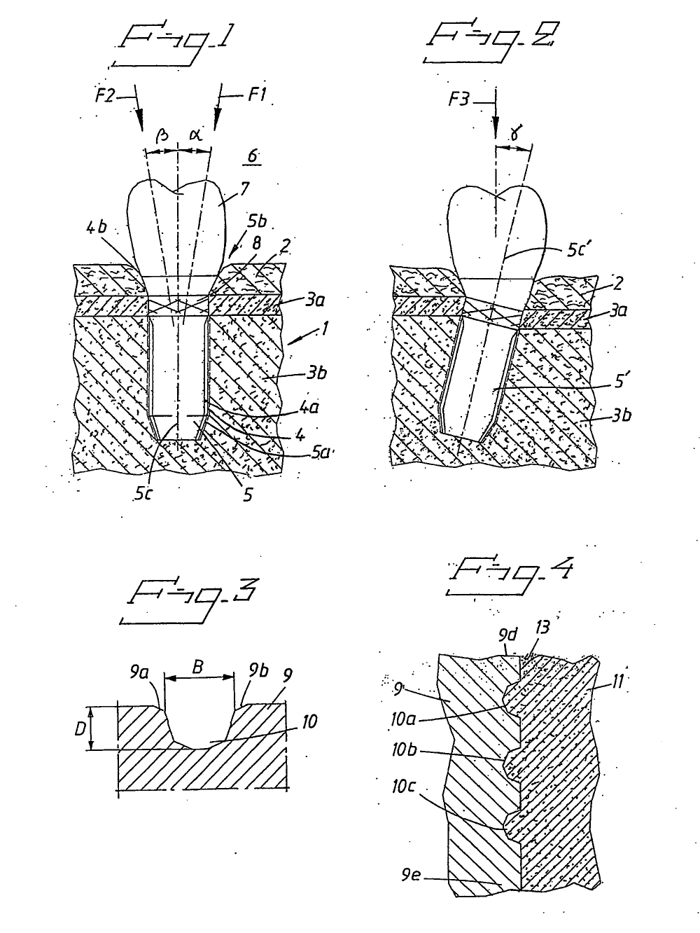

FIG. 1 is a diagrammatic vertical cross section through an implantation in the jaw bone where forces acting on the implant have directions/principal directions differing from the longitudinal direction of the implant,

FIG. 2 is a diagrammatic vertical cross section through an implant which is inclined in the implantation site in the jaw bone, with the result that a force with a vertical direction of action differs from the longitudinal extent of the implant,

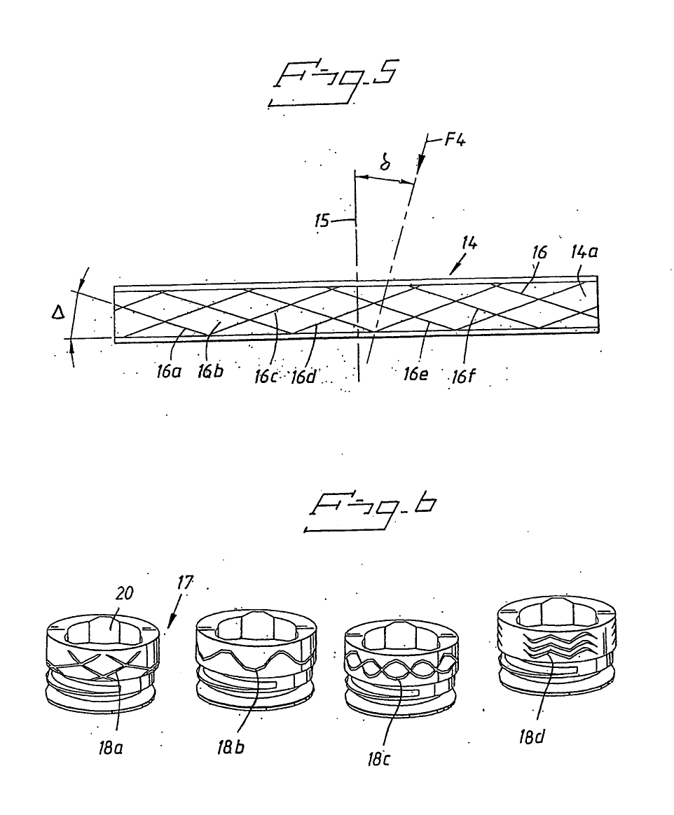

FIG. 3 is an enlarged vertical cross section through a type of groove or recess which contributes to excellent osteoconduction,

FIG. 4 is a vertical view of the closed groove or recess arrangement in which bacteria are prevented from moving from the upper parts to the lower parts,

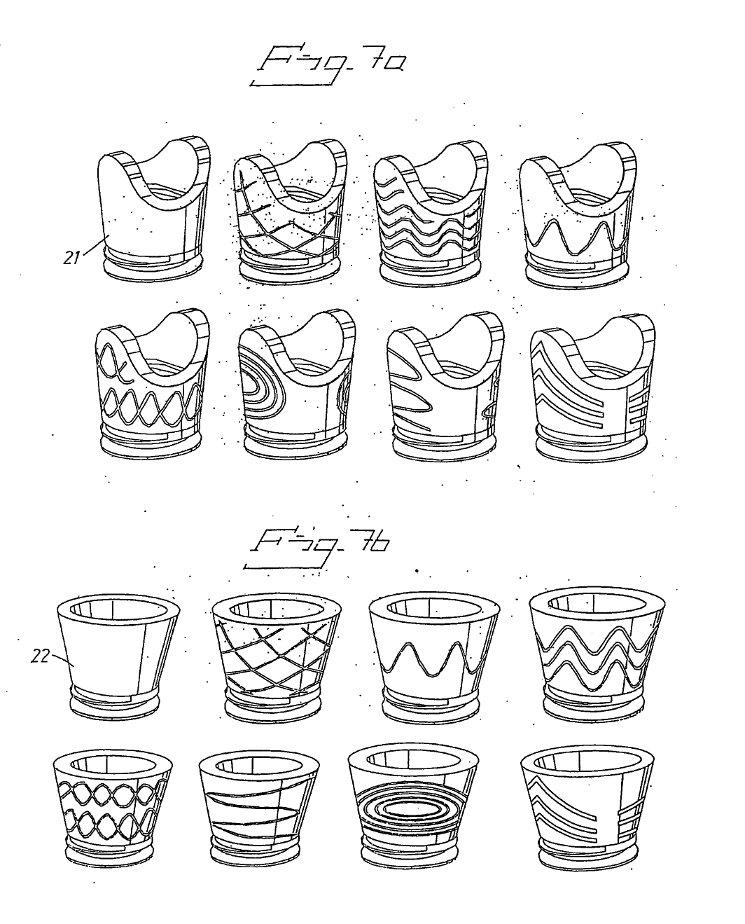

FIG. 5 is a side view of a first pattern arrangement, developed in the plane of the figure,

FIG. 6 is a perspective view, obliquely from above, showing parts of an implant with a number of different pattern arrangements, and

FIG. 7 is a perspective view, obliquely from above, showing parts of two other types of implants with a number of different pattern arrangements.

In FIG. 1, a jaw bone is shown diagrammatically by reference number 1. The jaw bone comprises a soft tissue part 2 and, lying under this, a bone part consisting of cortical bone 3a and spongy bone 3b. The jaw bone is provided with a hole 4. An implant 5 is fitted in the hole. The hole can have an internal thread 4a, and the implant is provided with an external thread 5a, by means of which the implant can be screwed into the hole in a manner known per se. The implant is provided with an upper or outer portion 5b which, when the implant is in position in the jaw bone, can be regarded as being situated in or surrounded by the soft tissue 2. Said portion is also arranged at the outlet opening 4b from the hole 4 to the oral cavity, which is indicated symbolically by 6. The implant is intended to support a prosthesis indicated symbolically by reference number 7. The upper portion 5b of the implant is provided with a pattern 8 of grooves and/or recesses. In accordance with the concept of the invention, the grooves and/or recesses in the pattern are arranged such that some of the grooves and/or recesses, for example 20% or more, will be substantially at right angles with respect to the forces acting on the implant when said implant is in the implanted position. Examples of impinging forces and their directions are indicated by F1 and F2. On account of the situation in the oral cavity, the prosthesis type, implant position, etc., the forces F1 and/or F2 can have principal directions differing from the longitudinal axis 5c of the implant. These differences have been defined in FIG. 1 with the aid of angles α and β. Each angle in cross section thus gives the difference between the respective direction of each impinging force.

The differences between the longitudinal axis of the implant and the principal direction of the force can also be caused by the implant assuming an oblique position. Such an example is shown in FIG. 2 where the implant 5′ is set obliquely in the parts 2 and 3 of the jaw bone 1. The longitudinal axis 5c′ of the implant thus slopes in the jaw bone, and a force F3 applied vertically to the implant has a principal direction differing from said longitudinal axis 5c′ by an angle γ. In this case too, some of the grooves and/or recesses are arranged substantially at right angles to the principal direction of the force F3.

FIG. 3 is intended to show an example of a very advantageous groove construction which also promotes the aforementioned osteoconduction. The groove or the recess will have a depth D in the range of 50-100 μm, preferably of the order of ca. 70 μm. The width or breadth B of the groove will be chosen in the range of 100-150 μm and will preferably be ca. 110 μm. The groove or recess is arranged in the upper portion of the implant (see 5b in FIG. 1). In FIG. 3, the portion has been designated by 9. The groove has been given reference number 10. The value B is calculated or measured at the positions of the bevel 9a and 9b.

In accordance with what has been stated above, said grooves will preferably form a closed system. In accordance with FIG. 4, the jaw bone part 11 bears via its inner surface against the portion 9. In FIG. 4, said groove or recess arrangement is represented by groove parts 10a, 10b and 10c which, in FIG. 4, extend substantially at right angles to the plane of the figure. In FIG. 4, growth of bone established in the groove has also been shown and is indicated by 12. In accordance with the concept of the invention, said groove arrangements 10a, 10b and 10c are not open toward the upper parts 9d of the portion 9 and the lower parts 9e of said portion, with the result that any accumulation of bacteria and/or organisms 13 cannot penetrate down from said upper parts 9d to the deeper-lying parts 9e of the implant. In this way it is possible to effectively prevent inflammation tendencies in said underlying parts which would be caused by said bacteria and/or organisms.

In FIG. 5, the aforementioned portion is indicated by 14. In the present case, the portion is shown developed in a plane. The longitudinal axis of the implant is in this case designated by 15, and an oblique impinging force is indicated by F4. The principal direction of the force F4 is indicated by a dot-and-dash line. The angle between the principal direction of the force F4 and the longitudinal axis 15 is indicated by δ. The pattern indicated in FIG. 5 is shown by 16. The pattern is composed of a set of parallel groove parts 16a, 16b, 16c, 16d, 16e and 16f. The distance between the groove parts can be the same or can vary between the various groove parts. The sets of groove parts are angled in relation to one another by an angle Δ, so that the grooves have at least two directions of inclination. In one embodiment of the pattern arrangement, the angle range for Δ can be chosen within 10-45°. The impinging force F4 can in principle be divided into a vertical force component which coincides with or extends parallel to the longitudinal axis 15, and a horizontal force component which extends at right angles in relation to said longitudinal axis 15. The pattern arrangement can be configured such that the vertical force component substantially exceeds the horizontal force component, so that forces are effectively taken up by the groove arrangement even in the case where the force direction of F4 is not entirely at right angles to the actual groove part, for example groove part 16e. The groove parts and/or recesses can extend all round the peripheral surface 14a or along selected parts of the surface as seen in the circumferential direction, thereby forming groups of patterns.

FIG. 6 shows a number of other embodiments of pattern arrangements at the upper, cylindrical portion 17 of the implant. The pattern configuration in question can consist of a sinusoidal arrangement disposed so that forces are taken up in accordance with the above. The implant in this case is provided with an internal socket for a turning tool (not shown). The socket is indicated by 20 and can be a socket with two or more wings, a toothed socket, a polygonal socket, etc. In this case, the portion 17 is provided with a number of pattern arrangements 18a, 18b, etc., along the circumferential surface 17. The arrangement of patterns can be provided at locations which, because of the socket arrangement 20, have a greater thickness, than other locations. This avoids undue weakening of the portion at parts of lesser thickness.

FIG. 7 shows a number of embodiments of patterns, on the one hand on what is called a scalloped implant 21, see FIG. 7a, and on the other hand on an implant with a conical circumferential surface 22, see FIG. 7b. Regarding scalloped implants, reference is made for example to WO 03/059189. The pattern arrangement can be divided up along the surface in the same way as in the case according to FIG. 6. A common feature of the pattern arrangement parts is that they have at least two directions of inclination.

Different implants with different patterns can be made available on the general market. The implants with the different patterns can be provided for different main types of implantation cases. The illustrative embodiments according to FIGS. 1 and 2 can relate to a case where different implantation situations are present in the same patient. The inclinations of the principal directions of the impinging force or forces are dependent oh the use (chewing movements) and positions and on the tooth type which the prosthesis in question is intended to represent. Said portion of the implant can consist of a flanged portion.

The invention is not limited to the embodiment shown by way of example above, and instead it can be modified within the scope of the attached patent claims and the inventive concept.

1. A dental implant for insertion into a hole formed in a jaw bone and exposure to an impinging force or impinging forces, the dental implant comprising one or more peripherally extending surfaces which are arranged at an upper/outer portion of the dental implant and are configured to be placed against a jaw bone part at an outlet opening of the hole, wherein each of the one or more peripherally extending surfaces are provided with a pattern of grooves and/or recesses in which greater than 20% of the grooves and/or recesses are configured so that, in the hole, the pattern of grooves and/or recesses extend substantially at right angles to or parallel to, said impinging forces when these impinging forces assume principal directions differing from the longitudinal direction of the implant.

2. The dental implant. as in claim 1, wherein the grooves and/or recesses are have no connection to the upper and/or lower portion.

3. The dental implant as in claim 1, wherein the grooves and/or recesses have a depth which lies in the range if 50-100 μm.

4. The dental implant as in claim 1, wherein in that the grooves and/or recesses have a width in the range of 100-150 μm.

5. The dental implant as in claim 1, wherein the upper/outer portion has an inner socket which is polygonal, toothed or with two or more wings, and the grooves and/or the recesses are arranged at parts of greater material thickness at the upper/outer portion.

6. The dental implant as in claim 1, wherein the pattern comprises straight and parallel groove parts with at least two directions of inclination and are arranged round all or part of the peripheral surface, and in that the groove parts extend relation to a cross section through the surface.

7. The dental implant as in claim 1, wherein the pattern comprises sinusoidal groove recess parts.

8. The dental implant as in claim 1, wherein the pattern comprises one or more groups of grooves arranged mutually parallel and with different longitudinal extents.

9. The dental implant as in claim 1, wherein the peripherally extending surfaces are formed on a flange arrangement.

10. The dental implant as in claim 1, wherein the principal direction of the impinging force for the most part is oblique in relation to the longitudinal direction of the fitted implant, because the implant assumes an inclined position in the hole formed in the jaw bone.

11. The dental implant as in claim 1, wherein the principal direction of the impinging force or forces is for the most part oblique in relation to the fitted implant, because of the oblique settings of impinging force or forces in the implantation environment.

12. The dental implant as in claim 1, wherein the groove or recess pattern is unique for a first implant design which differs in respect of this pattern from a second implant design.

13. The dental implant as in claim 1, wherein the implant is exposed to forces with mutually different directions, and in that a. first part or parts of the groove and/or recess pattern is/are substantially at right angles in relation to a first force direction and in that a second part or parts of the pattern is/are substantially at right angles in relation to a second force direction and, if appropriate, so on, if a further force direction or force directions present.

14. The dental implant as in claim 9, wherein in said flange arrangement is cylindrical.

15. The dental implant as in claim 9, wherein in said flange arrangement is conical.

16. The dental implant as in claim 9, wherein in said flange arrangement is scalloped.
